(19) United States
(12) Patent Application Publication
(10) Pub. No.: US 2011/0151139 A1
(43) Pub. Date: Jun. 23, 2011

(54) METHOD FOR SELECTIVELY FUNCTIONALIZING NON-MODIFIED SOLID SURFACE AND METHOD FOR IMMOBILIZING ACTIVE MATERIAL ON THE FUNCTIONALIZED SOLID SURFACE

(75) Inventors: An Soon KIM, Daejeon (KR); Wan Joong Kim, Goyang (KR); Chil Seong Ah, Daejeon (KR); Chan Woo Park, Daejeon (KR); Jong Heon Yang, Daejeon (KR); Tae Youb Kim, Seoul (KR); Chang Geun Ahn, Daejeon (KR); Gun Yong Sung, Daejeon (KR)

(73) Assignee: Electronics and Telecommunications Research Institute, Daejeon (KR)

(21) Appl. No.: 12/944,655

(22) Filed: Nov. 11, 2010

(30) Foreign Application Priority Data
Dec. 17, 2009 (KR) 10-2009-0126051

(51) Int. Cl. B05D 3/06; B05D 3/00; B05D 3/10

(52) U.S. Cl. 427/558; 427/331; 427/353

(57) ABSTRACT

A method for selectively functionalizing a non-modified solid surface to create a photoresponsive coating layer includes: functionalizing a non-modified solid surface only, which is not oxidized and nitrified, with hydrogen; forming an EGPA coating layer on the non-modified solid surface functionalized with hydrogen using light; forming an EGA coating layer by removing an amine protecting group or an amine salt from the EGPA coating layer; and forming a coating layer having a photoresponsive functional group on the non-modified solid surface using the EGA coating layer.

### CROSS-REFERENCE TO RELATED APPLICATIONS

This application claims the priority of Korean Patent Application No. 10-2009-0126051 filed on Dec. 17, 2009, in the Korean Intellectual Property Office, the disclosure of which is incorporated herein by reference.

### BACKGROUND OF THE INVENTION

1. Field of the Invention

The present invention relates to a method for selectively functionalizing a non-modified solid surface to create a photoresponsive coating layer and a method for immobilizing an active material using the photoresponsive coating layer, and more particularly, to technologies for selectively functionalizing only a non-modified solid surface to create a surface having a functional group that is chemically active and responsive to light, and for immobilizing an active material such as a biomaterial and a functional material on the functionalized solid surface through strong and stable chemical bonding by irradiating light onto the functionalized solid surface.

2. Description of the Related Art

A chemical self-assembly technique, which has been widely used to selectively functionalize only a specific solid surface in the past, has several problems such as a difficulty in reaction condition control, surface nonuniformity due to oxidation, chemical diversity, and a difficulty in selective surface modification.

To solve these problems, a method for selectively immobilizing deoxyribonucleic acid (DNA) on only a silicon surface by adding a crosslinker has been suggested, however, such a method causes a monomolecular film to become thicker. Therefore, there is a limitation to applying this method to a field effect transistor (FET) in which a monomolecular film formed on a device surface should be thinned for accomplishing the field effect, and there is another limitation in that reactivity of protein with a modified surface is very weak in a protein chip that utilizes proteins other than DNA.

Accordingly, another method has been proposed which enables a biomaterial, a functional material, or the like, to be immobilized on a functionalized solid surface through strong and stable bonding by selectively functionalizing a non-modified solid surface with an aldehyde group without using a crosslinker.

However, according to this method, since an active material such as a biomaterial is also immobilized on the functionalized solid surface through chemical bonding, the method has disadvantages that it is difficult to selectively bond the active material to a desired part that is extremely small and it takes a comparatively long time (about 12 hours) to immobilize the active material.

### SUMMARY OF THE INVENTION

An aspect of the present invention provides a method for selectively functionalizing a non-modified solid surface and a method for immobilizing an active material using a photoresponsive coating layer, which can selectively functionalize only a non-modified solid surface to create a surface having a functional group that is chemically active and responsive to light, and can immobilize an active material such as a biomaterial and a functional material on the functionalized solid surface through strong and stable chemical bonding by irradiating light onto the functionalized solid surface.

According to an aspect of the present invention, there is provided a method for selectively functionalizing a non-modified solid surface to create a photoresponsive coating layer, including: functionalizing a non-modified solid surface only, which is not oxidized and nitrified, with hydrogen; forming an ethylene glycol protected amine (EGPA) coating layer on the non-modified solid surface functionalized with hydrogen using light; forming an ethylene glyfol amine (EGA) coating layer by removing an amine protecting group or an amine salt from the EGPA coating layer; and forming a coating layer having a photoresponsive functional group on the non-modified solid surface using the EGA coating layer.

The functionalizing of the non-modified solid surface only may include functionalizing the non-modified solid surface only with hydrogen by dipping a substrate including the non-modified solid surface in a 30:1 buffered oxide etch (BOE) solution for about 10 seconds.

The forming of the EGPA coating layer may include: coating EGPA on the non-modified solid surface functionalized with hydrogen, and irradiating 254-nm UV light; and removing a multilayer by performing sonication in ethanol (EtOH). The EGPA may have a configuration including an aryl group, an ethylene glycol group, and an amine protecting group or amine salt.

Also, the forming of the EGA coating layer may include forming an amino group by adding trifluoroacetic acid (TFA) to the amine protecting group of the EGPA coating layer, or include rinsing the amine salt of the EGPA coating layer with distilled water.

In the forming of the coating layer having the photoresponsive functional group, the non-modified solid surface may be functionalized with diazirine by adding molecules containing an N-hydroxysuccinimide group and diazirine to a substrate including the non-modified solid surface.

According to another aspect of the present invention, there is provided a method for immobilizing an active material using a photoresponsive coating layer, including: functionalizing a non-modified solid surface only to create a photoresponsive coating layer; and immobilizing an active material by bringing the active material into contact with the functionalized non-modified solid surface and irradiating light thereupon.

In the functionalizing of the non-modified solid surface to create a photoresponsive coating layer, only the non-modified solid surface may be modified by including: functionalizing the non-modified solid surface only, which is not oxidized and nitrified, with hydrogen; forming an EGPA coating layer on the non-modified solid surface functionalized with hydrogen using light; forming an EGA coating layer by removing an amine protecting group or an amine salt from the EGPA coating layer; and forming a coating layer having a photoresponsive functional group on the non-modified solid surface using the EGA coating layer.

Also, in the immobilizing of the active material, the active material may be immobilized by bringing the active material into contact with the non-modified solid surface functionalized with the diazirine and irradiating 365-nm UV light thereupon. The active material may be selected from the group consisting of biomaterials, functional materials, nanomaterials, and polymers.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram illustrating a silicon substrate used in a method for selectively functionalizing a non-modified solid surface according to the present invention;

FIGS. 2A and 2B are schematic diagrams illustrating a procedure of selectively functionalizing a non-modified solid surface to create a photoresponsive coating layer according to an embodiment of the present invention;

FIG. 3 illustrates configurations of molecules used for selectively functionalizing a non-modified solid surface according to the present invention; and

FIG. 4 is a schematic diagram illustrating a procedure of immobilizing an active material using a photoresponsive coating layer according to an embodiment of the present invention.

### DETAILED DESCRIPTION OF THE PREFERRED EMBODIMENT

Hereinafter, exemplary embodiments of the present invention will be described with reference to the accompanying drawings to fully explain the present invention in such a manner that it may easily be carried out by a person with ordinary skill in the art to which the present invention pertains. In the detailed description of exemplary embodiments of the present invention below, detailed descriptions related to well-known functions or configurations will be left out in order not to unnecessarily obscure subject matters of the present invention. Throughout the drawings, like reference numerals denote like elements performing the same function and action.

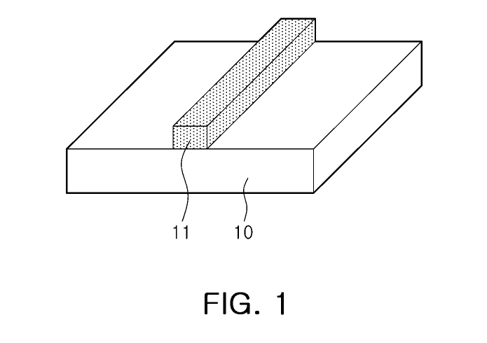

FIG. 1 is a diagram illustrating a silicon substrate used in a method for selectively functionalizing a non-modified solid surface according to the present invention.

For example, the silicon substrate used herein has a structure in which a non-modified solid surface 11 is disposed on a portion of a modified substrate 10, as illustrated in FIG. 1. Here, the non-modified solid surface 11 means a solid surface that is not oxidized or nitrified. In the present invention, only the non-modified solid surface 11 is selectively functionalized into a surface having a functional group which is chemically active and responsive to light.

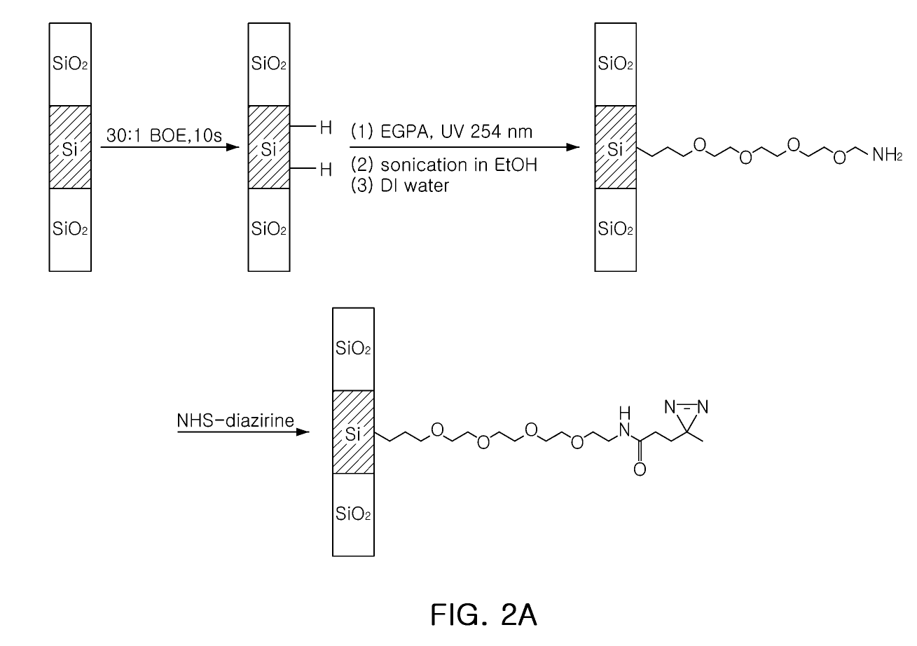

FIGS. 2A and 2B are schematic diagrams illustrating a procedure of selectively functionalizing a non-modified solid surface to create a photoresponsive coating layer according to an embodiment of the present invention.

Referring to FIG. 2A, a non-modified solid surface is functionalized with hydrogen first. To this end, a silicon substrate is dipped in a buffer solution such as a 30:1 buffered oxide etch (BOE) solution for 10 seconds. The BOE solution is typically used as an etchant in a semiconductor process.

Thereafter, light is used to form an EGPA coating layer on the non-modified solid surface functionalized with hydrogen. To form the EGPA coating layer, the non-modified solid surface functionalized with hydrogen is coated with EGPA, and 254-nm UV light is then irradiated onto the non-modified solid surface. Afterwards, sonication is performed in ethanol (EtOH) so as to remove a multilayer.

Next, an amine protecting group or amine salt of the EGPA coating layer is removed to thereby form an EGA coating layer. Specifically, as illustrated in FIG. 2A, the EGA coating layer may be selectively formed on only the non-modified solid surface, i.e., the silicon surface, by rinsing the amine salt of the EGPA coating layer with distilled water (DI water). Alternatively, as illustrated in FIG. 2B, the EGA coating layer may also be formed by forming an amino group by adding trifluoroacetic acid (TFA) to the amine protecting group of the EGPA coating layer.

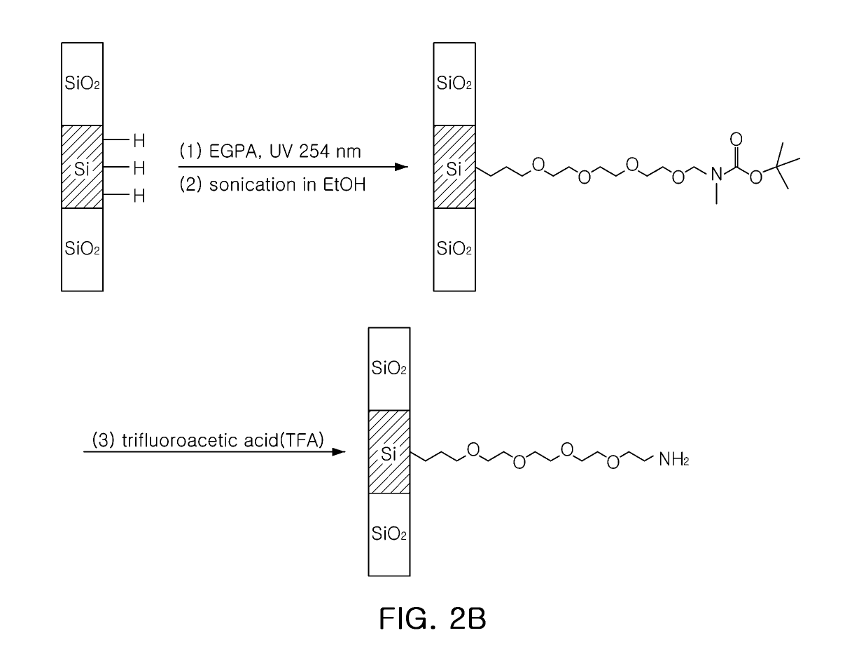

FIG. 3 illustrates configurations of EGPA molecules used for selectively functionalizing a non-modified solid surface according to the present invention. The molecule is configured with an aryl group that can be responsive to light, an ethylene glycol group for protecting the nonspecific bonding of an active material, and an amino protecting group or amine salt for protecting amino from being broken due to light. FIG. 3(a) illustrates a molecular configuration including an amine salt, and FIG. 3(B) illustrates a molecular configuration including an amino protecting group.

Referring to FIG. 2A again, in order to form a coating layer having a photoresponsive functional group on the non-modified solid surface after forming the EGA coating layer, the non-modified solid surface is functionalized with diazirine by adding molecules which contain an N-hydroxysuccinimide group reacting with an amino group and photoresponsive diazirine to the silicon substrate.

Through such a procedure, only the non-modified solid surface can be selectively functionalized to create the photoresponsive coating layer on the silicon substrate.

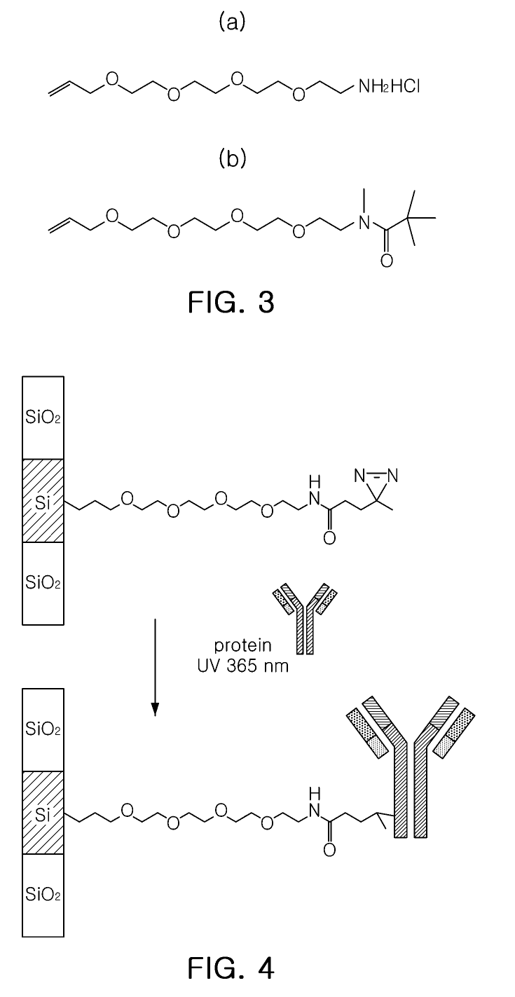

FIG. 4 is a schematic diagram illustrating a procedure of immobilizing an active material using a photoresponsive coating layer according to an embodiment of the present invention.

According to the present invention, the active material may be immobilized by bringing an active material (for example, a protein) into contact with the non-modified solid surface functionalized with the diazirine through the procedure shown in FIG. 2A or FIG. 2B and by irradiating 365-nm UV light onto the non-modified solid surface. Since it takes about 5 minutes to immobilize the active material, the time taken for immobilizing the active material is greatly shortened in the inventive method when compared to the related art method.

The active material used herein means a biomaterial, a functional material, a nanomaterial, or a polymer which can bind to the non-modified solid surface. Here, the biomaterial may be DNA, RNA, an antibody, an antigen, an enzyme, a cell, or a bacterium. The functional material may be an antibacterial active material, a gas absorptive material, a magnetic material, or a photonic material. The nanomaterial may be a quantum dot, a nanodot, a nanowire, a nanotube, a nano porosity material, a nano-plate or a nanorod. The polymer may be a carbon compound having a molecular weight of 10,000 or more, which contains nitrogen, oxygen, or sulfur.

As set forth above, according to exemplary embodiments of the invention, an active material is immobilized by selectively irradiating light onto a solid surface functionalized so as to have a functional group that is chemically active and responsive to light, thus making it possible to selectively bind the active material to a desired part thereof.

Also, a time taken for immobilizing the active material on the functionalized solid surface is about 5 minutes, which is significantly shorter than a time taken in the related art method of functionalizing a solid surface with an aldehyde group and immobilizing the active material on the functionalized solid surface

While the present invention has been shown and described in connection with the exemplary embodiments, it will be apparent to those skilled in the art that modifications and variations can be made without departing from the spirit and scope of the invention as defined by the appended claims.

What is claimed is:

1. A method for selectively functionalizing a non-modified solid surface to create a photoresponsive coating layer, the method comprising:
functionalizing a non-modified solid surface only, which is not oxidized and nitrified, with hydrogen;
forming an EGPA coating layer on the non-modified solid surface functionalized with hydrogen using light;
forming an EGA coating layer by removing an amine protecting group or an amine salt from the EGPA coating layer; and
forming a coating layer having a photoresponsive functional group on the non-modified solid surface using the EGA coating layer.

2. The method of claim 1, wherein the functionalizing of the non-modified solid surface only comprises functionalizing the non-modified solid surface only with hydrogen by dipping a substrate including the non-modified solid surface in a 30:1 buffered oxide etch (BOE) solution for about 10 seconds.

3. The method of claim 1, wherein the forming of the EGPA coating layer comprises:
coating EGPA on the non-modified solid surface functionalized with hydrogen, and irradiating 254-nm UV light; and
removing a multilayer by performing sonication in ethanol (EtOH).

4. The method of claim 3, wherein the EGPA has a configuration including an aryl group, an ethylene glycol group, and an amine protecting group or amine salt.

5. The method of claim 1, wherein the forming of the EGA coating layer comprises forming an amino group by adding trifluoroacetic acid (TFA) to the amine protecting group of the EGPA coating layer.

6. The method of claim 1, wherein the forming of the EGA coating layer comprises rinsing the amine salt of the EGPA coating layer with distilled water.

7. The method of claim 1, wherein, in the forming of the coating layer having the photoresponsive functional group, the non-modified solid surface is functionalized with diazirine by adding molecules containing an N-hydroxysuccinimide group and diazirine to a substrate including the non-modified solid surface.

8. A method for immobilizing an active material using a photoresponsive coating layer, the method comprising:
functionalizing a non-modified solid surface only to create a photoresponsive coating layer; and
immobilizing an active material by bringing the active material into contact with the functionalized non-modified solid surface and irradiating light thereupon.

9. The method of claim 8, wherein the functionalizing of the non-modified solid surface to create a photoresponsive coating layer comprises:
functionalizing the non-modified solid surface only, which is not oxidized and nitrified, with hydrogen;
forming an EGPA coating layer on the non-modified solid surface functionalized with hydrogen using light;
forming an EGA coating layer by removing an amine protecting group or an amine salt from the EGPA coating layer; and
forming a coating layer having a photoresponsive functional group on the non-modified solid surface using the EGA coating layer.

10. The method of claim 8, wherein, in the functionalizing of the non-modified solid surface to create a photoresponsive coating layer, only the non-modified solid surface is functionalized with diazirine.

11. The method of claim 10, wherein, in the immobilizing of the active material, the active material is immobilized by bringing the active material into contact with the non-modified solid surface functionalized with the diazirine and irradiating 365-nm UV light thereupon.

12. The method of claim 8, wherein the active material is selected from the group consisting of biomaterials, functional materials, nanomaterials, and polymers.
